(19) United States
(12) Patent Application Publication
(10) Pub. No.: US 2007/0000852 A1
(43) Pub. Date: Jan. 4, 2007

(54) SUPPORT FOR HUNTING WEAPON

(76) Inventor: Pawel Wajchert, Pabianice (PL)

Correspondence Address: MYERS WOLIN, LLC, 100 HEADQUARTERS PLAZA, MORRISTOWN, NJ, 07960, US

(21) Appl. No.: 11/425,132

(22) Filed: Jun. 19, 2006

(30) Foreign Application Priority Data
Jun. 20, 2005 (PL) P 375807

(51) Int. Cl. B60R 7/14

(52) U.S. Cl. 211/64

(57) ABSTRACT

Support for hunting weapon has five rigid components (1), (2), (3), (4) and (5), of roughly equal length, mutually connected in movable manner, the four of which components (2), (3), (4), and (5), are being connected at their upper and lower parts, while the fifth component (1) is being connected to the structure only at its upper part, where the upper parts of the four rigid components which are being connected in two locations form a letter “V” (6) and the four rigid components are connected by means of elastic links (7). The support upon folding, it takes form of a narrow slat upon folding.

### FIELD OF THE INVENTION

The object of this invention is a new and original support for hunting gun designed mainly for putting upon it a shotgun or heavy hunting gun, intended particularly for hunters using firearms in various ground conditions.

### BACKGROUND

There are known various kinds of supports for hunting weapons. One of them is known from Polish patent pending No P-358117, titled: “Stand for weapon, preferably for hunting weapon” which has a form of tripod, the legs of which are mounted pivotally into an annular casing. In this stand, the angular casing is provided with a bush, inside which a slidable tube is mounted, connected with a supporting housing by means of a fixing pin.

### SUMMARY OF THE INVENTION

The present invention consists of a support having five rigid components of roughly equal length, mutually, movably connected, the four of which being connected movably at both upper and lower parts, and the fifths rigid component being connected with the structure only at its upper part, while upper parts of said four rigid components connected in two places form a letter “V” and said four rigid components being interconnected by means of three elastic links. After folding, the support takes form of a slat.

The support for hunting weapon according to this invention is composed of movably connected five rigid components of roughly equal length. Four out of five of these rigid components being connected movably at their upper and lower parts, while the fifths rigid component is being connected with the structure only at it upper part. This arrangement enables to set-up the support in stable manner on the ground and to adjust its height at will. Connection of the fifth component to the structure in only one location stabilizes the structure. The upper parts of the four rigid components connected in two places, form a letter “V”, upon which the gun is to be placed. The four rigid components are interconnected by means of three flexible links, which prevents any incidental collapsing of the structure. The weapon is to be put upon the support over the movable connection of the four rigid components, that means on the components forming letter “V”. All the components are being connected in movable manner. Such movable connection of all rigid components enables to perform a stable set-up of the structure on the ground, as well as to adjust of its heights at will. Connection of the fifth component to the structure only in one location constitutes stabilizing factor of the whole structure.

### BRIEF DESCRIPTION OF THE DRAWING

The present invention is illustrated, but not limited to, in preferred example of embodiment on the accompanying drawing on which:

FIG. 1 shows the support in set-up form, viewed from the front,

FIG. 2 shows the schema of the support in set-up form,

FIG. 3 shows the side view of the support, and

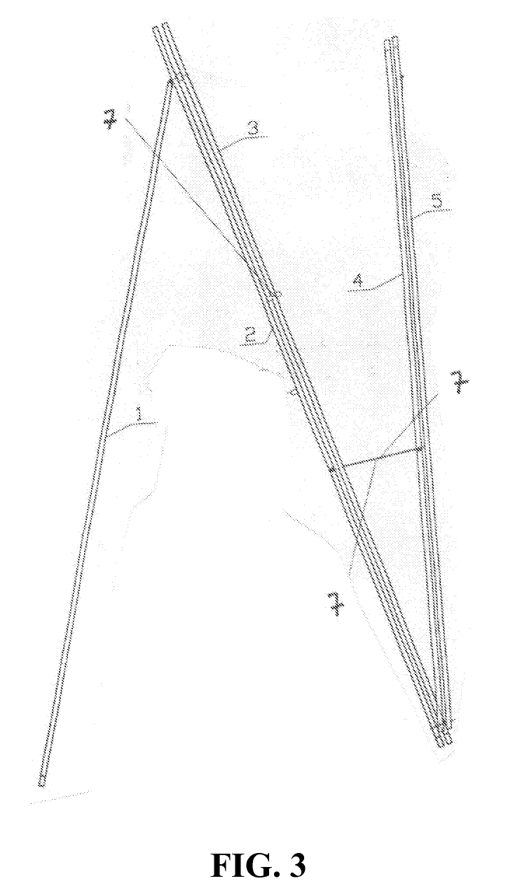

FIG. 4 shows the support in folded form.

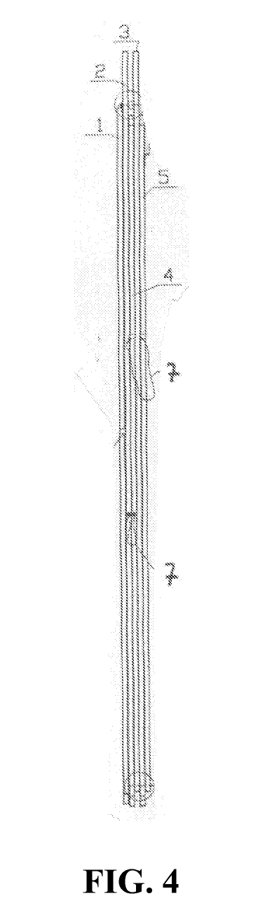

### DETAILED DESCRIPTION OF THE PREFERRED EMBODIMENT

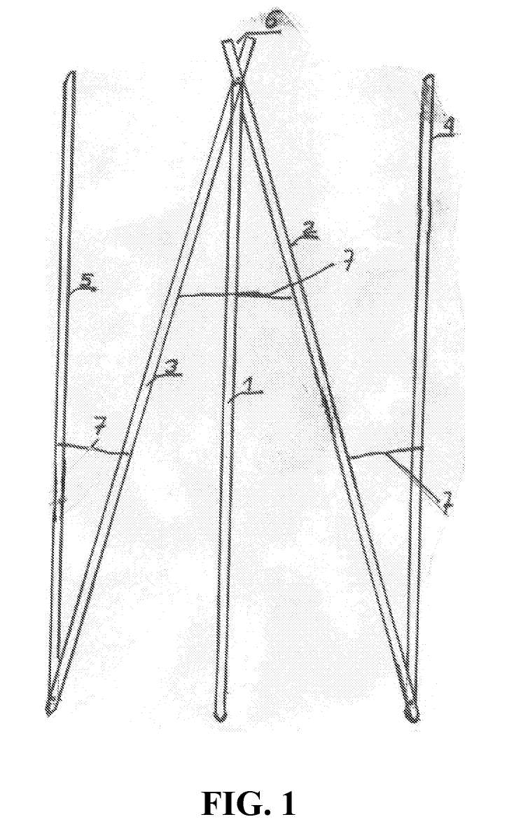

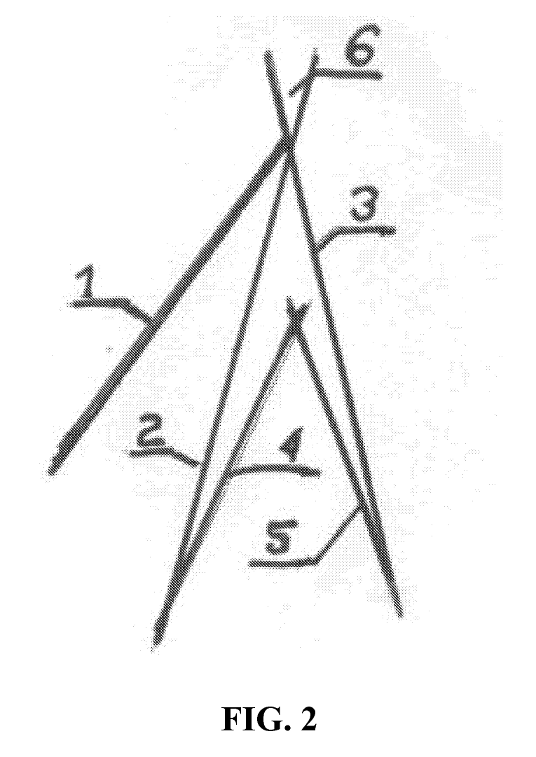

The support for hunting weapon consists of five movably interconnected rigid components (1), (2), (3), (4) and (5), of roughly equal length. Four of these five components (2), (3), (4) and (5) are connected at their upper and lower parts, while the fifth rigid component (1) is connected to the structure only at its upper part. This arrangement enables stable setting-up of the support on the ground, as well as adjusting its height at will. Connection of the fifths rigid component (1) in only one location constitutes a stabilizing factor for the structure. Upper parts of the four rigid components, which are connected in two locations, form a letter “V” (6), upon which the gun is to be placed. Elements (4) and (5), on FIG. 1 are shown in spread position, which, upon folding on each other, form a letter “V” as is illustrated on FIG. 2. The four rigid components (2), (3), (4) and (5) are interconnected by flexible links (7), which prevent collapsing of the structure. The weapon is to be put on the support over the movable connection of the four rigid components (2), (3), (4) and (5), that means on the components forming letter “V”. All components are being connected in movable manner. Such movable connection of all rigid components enables to perform a stable set-up of the structure on the ground, as well as to adjust of its heights at will. Connection of the fifth component to the structure only in one location constitutes stabilizing factor of the whole structure.

The support for hunting weapon, after folding, takes form of a narrow slat. All rigid components (1), (2), (3), (4) and (5) become parallel forming one, narrow surface.

The scope of the invention is not limited to the example of embodiment.

What is claimed is:

1. A support for hunting weapon comprising:
five rigid components (1), (2), (3), (4) and (5), of roughly equal length, mutually connected in a movable manner to form the support, each having upper and lower parts,
four of the five rigid components (2), (3), (4), and (5) being connected at their upper and lower parts, while the fifth rigid component (1) is connected to the support only at its upper part,
wherein the upper parts of the four of the five rigid components which are being connected in two locations form a letter “V” (6) and the four rigid components are connected by means of elastic links (7).

2. A support for hunting weapon, according to claim 1, wherein upon folding, it takes the form of a narrow slat.
